(19) United States
(12) Patent Application Publication
(10) Pub. No.: US 2026/0042257 A1
(43) Pub. Date: Feb. 12, 2026

(54) EXTRUSION PRINTABLE CELLULOSE-BASED NANOCOMPOSITE AND METHOD OF MAKING SAME

(71) Applicants: Xiaowu (Shirley) TANG, Waterloo (CA); Sayan GANGULY, Kitchener (CA)

(72) Inventors: Xiaowu (Shirley) TANG, Waterloo (CA); Sayan GANGULY, Kitchener (CA)

(21) Appl. No.: 19/297,086

(22) Filed: Aug. 12, 2025

Related U.S. Application Data
(60) Provisional application No. 63/732,400, filed on Aug. 12, 2024.

(51) Int. Cl. B29C 64/314; B29C 64/118; B29C 64/30; B29C 71/02; B29K 1/00; B29K 105/00; B29K 401/00; B33Y 10/00; B33Y 40/20; B33Y 70/00; C09D 7/20; C09D 101/12

(52) U.S. Cl. CPC B29C 64/314; B29C 64/118; B29C 64/30; B29C 71/02; B33Y 10/00; B33Y 40/20; B33Y 70/00; C09D 7/20; C09D 101/12; B29C 2071/025; B29K 2001/12; B29K 2105/0073; B29K 2401/08

(57) ABSTRACT

The disclosure is directed at an extrusion printable cellulose-based nanocomposite and method of making same. In some embodiments, the disclosure is directed at a cellulose-based ink or nanocomposite that can be used by a three-dimensional (3D) extrusion-type printer to fabricate or print a 3D object. In some embodiments, the disclosure includes cellulose acetate (CA) that is dissolved in a solvent or solvent mixture to produce a CA solution to which cellulose nanocrystals (CNCs) are then added to prepare the ink or nanocomposite of the disclosure.

### CROSS-REFERENCE TO OTHER APPLICATIONS

The current disclosure claims priority from U.S. Provisional Application No. 63/732,400 filed Aug. 12, 2024 which is hereby incorporated by reference.

### FIELD OF THE DISCLOSURE

The current disclosure is generally directed at three-dimensional (3D) printable inks or nanocomposites and, more specifically at, an extrusion printable cellulose-based nanocomposite and method of making same.

### BACKGROUND OF THE DISCLOSURE

Over the past several years, there has been research into biodegradable composites as a replacement for nondegradable petroleum-based materials. Cellulose and its derivatives have been widely used in various industries because they are derived from abundant sources, possess exceptional biodegradability and can be easily renewed. In general, cellulose can be converted into cellulose acetate (CA) through the process of acetylating its hydroxyl groups.

Use of cellulose acetate provides many benefits including its affordability, ability to break down naturally, compatibility with living organisms, lack of toxicity, resistance to water degradation, strong mechanical properties and resistance to chemical substances. Some applications or industries that use cellulose acetate include textiles, paper, pharmaceutical, membranes, water treatment, tissue engineering and biosensors.

Therefore, there is provided a novel extrusion printable cellulose-based nanocomposite and method of making same.

### SUMMARY OF THE DISCLOSURE

The disclosure is directed at an extrusion printable cellulose-based nanocomposite and method of making same. In some embodiments, the disclosure is directed at a cellulose-based ink or nanocomposite that can be used by a three-dimensional (3D) extrusion-type printer to fabricate or print a 3D object. In some embodiments, the disclosure includes cellulose acetate (CA) that is dissolved in a solvent or solvent mixture to produce a CA solution to which cellulose nanocrystals (CNCs) are then added to prepare the ink or nanocomposite of the disclosure. After the 3D object has been printed or fabricated, the 3D object can undergoes a post-printing processing treatment.

In one aspect of the disclosure, there is provided a method of producing an ink for extrusion printing by a three-dimensional printing including dissolving cellulose acetate (CA) powder in a solvent mixture to produce a CA solution; and adding cellulose nanocrystals (CNC) to the CA solution to produce the ink.

In another aspect, the solvent mixture includes at least two different liquid components. In a further aspect, the solvent mixture is a tri-solvent mixture. In yet another aspect, the tri-solvent mixture includes acetone, ethanol, and dimethyl sulfoxide (DMSO). In an aspect, dissolving CA powder in a solvent mixture includes adding CA powder to the solvent mixture in a container; and agitating, shaking, stirring or heating the container. In yet another aspect, the CA solution is between about 15 wt % to about 38 wt % CA. In yet another aspect, the ink is between about 1 wt % CNC to about 5 wt % CNC.

In another aspect of the disclosure, there is provided an ink for extrusion printing using a three-dimensional printer including a cellulose acetate (CA) powder; a solvent mixture; and cellulose nanocrystals (CNCs).

In another aspect, the CA powder is dissolved in the solvent mixture to produce a CA solution. In a further aspect, the ink includes about 15 wt % to about 38 wt % CA. In another aspect, the ink includes about 1 wt % to about 5 wt % CNC. In a further aspect, the solvent mixture includes acetone, ethanol, and dimethyl sulfoxide (DMSO).

In yet a further aspect of the disclosure, there is provided a method of fabricating a three-dimensional (3D) object including producing a cellulse-based ink; printing, via extrusion, the 3D object using a 3D printer; and performing a post-printing treatment to the 3D object.

In another aspect, producing a cellulose-based ink includes dissolving cellulose acetate (CA) powder in a solvent mixture to produce a CA solution; and adding cellulose nanocrystals (CNC) to the CA solution to produce the cellulose-based ink. In a further aspect, performing a post-printing treatment to the 3D object includes applying a porogen-based treatment to the 3D object. In another aspect, applying the porogen-based treatment to the 3D object includes rinsing the 3D object with n-hexane; cryofreezing the 3D object; and freeze drying the 3D object.

### BRIEF DESCRIPTION OF THE DRAWINGS

Further features and advantages of the present disclosure will become apparent from the following detailed description, taken in combination with the appended drawings, in which:

FIG. 1a is a flowchart showing a method of manufacturing an extrusion printable cellulose-based ink or nanocomposite;

FIG. 1b is a schematic diagram showing a specific embodiment of FIG. 1a;

FIG. 2a is a graph showing results from a steady state shear rate ramp test of different cellulose-based inks showing shear thinning behaviour;

FIG. 2b is a pair of photographs showing a cellulose-based ink before (left) and after (right) vial inversion;

FIG. 2c is a photograph showing ink consistency when a cellulose-based ink was extruded out from a tapered nozzle of a 3D printer;

FIG. 3 is a schematic diagram of cellulose acetate macrochains morphology before and after drying;

FIG. 4a is a scanning electron microscope (SEM) image of surface textures of a first embodiment (CA25) of a cellulose-based ink;

FIG. 4b is a SEM image of surface textures of a second embodiment (CA25CNC1) of a cellulose-based ink;

FIG. 4c is a SEM image of surface textures of a third embodiment (CA25CNC3) of a cellulose-based ink;

FIG. 4d is a SEM image of surface textures of a fourth embodiment (CA25CNC5) of a cellulose-based ink;

FIG. 5a is a SEM image of a surface of a 3D object without post-printing processing printed with the first embodiment (CA25) of a cellulose-based ink;

FIG. 5b is a SEM image of a surface of a 3D object after post-printing processing printed with the first embodiment (CA25) of a cellulose-based ink;

FIG. 5c is a magnified SEM image of FIG. 5b;

FIG. 5d is a SEM image of a surface of a 3D object after post-printing processing printed with the second embodiment (CA25CNC1) of a cellulose-based ink;

FIG. 5e is a magnified SEM image of FIG. 5d;

FIG. 5f is a SEM image of a surface of a 3D object after post-printing processing printed with the third embodiment (CA25CNC3) of a cellulose-based ink;

FIG. 5g is a magnified SEM image of FIG. 5f;

FIG. 5h is a SEM image of a surface of a 3D object after post-printing processing printed with the fourth embodiment (CA25CNC5) of a cellulose-based ink;

FIG. 5i is a magnified SEM image of FIG. 5h;

FIG. 6a is a stress-strain plot of the different embodiments of the cellulose-based inks;

FIG. 6b is a chart showing ultimate tensile strength and elongation at break of the different embodiments of the cellulose-based inks;

FIG. 6c is a chart showing measurements of Young's moduli of the different embodiments of the cellulose-based inks;

FIGS. 7a to 7d are photographs showing a compression test performed on a 3D object printed with a cellulose-based ink;

FIG. 7e is a photograph of a 3D object printed from a commercially available plastic after a compression test;

FIG. 7f is a photograph showing a top view of a 3D object printed from a cellulose-based ink after a compression test;

FIG. 7g is a photograph of a side view of the 3D object of FIG. 7f;

FIG. 7h is a graph showing a compressive stress-strain plot of the different embodiments of the cellulose-based inks;

FIG. 7i is a chart showing ultimate compressive strength of the different embodiments of the cellulose-based inks;

FIG. 8a is a photograph of a 3D object printed with the CA25 ink on a leaf;

FIG. 8b is a photograph of a 3D object printed with the CA25CNC3 ink on a leaf;

FIG. 8c is a photograph of the 3D objects of FIGS. 8a and 8b on a leaf;

FIG. 8d is a photograph showing a 3D object printed with a cellulose-based ink on a flower petal;

FIG. 8e is a set of photographs showing a 3D object printed with a cellulose-based ink being submerged under pressure in a container of dyed water;

FIG. 9a is a graph showing results from a Thermogravimetric analysis of the different embodiments of the cellulose-based ink;

FIG. 9b is a first enlarged portion of the graph of FIG. 9a showing onset of degradation;

FIG. 9c is a second enlarged portion of the graph of FIG. 9a showing residue formed after the Thermogravimetric analysis;

FIG. 9d is a histogram plot of the onset of degradation and residue of the cellulose-based inks;

FIG. 9e is a differential scanning calorimetry thermogram of the different embodiments of the cellulose-based ink;

FIG. 9f is a chart showing a shift of glass transition temperature of the different embodiments of the cellulose-based ink;

FIG. 10 is a set of photographs showing solvent resistance tests for a 3D object printed with a cellulose-based ink;

FIG. 11a is a graph showing corrosion time plot between an uncoated strip of aluminum and a strip of aluminum coated with a cellulose-based ink;

FIG. 11b is a histogram showing mass loss of the uncoated and coated strips of aluminum;

FIG. 11c are photographs showing the uncoated and coated strips of aluminum before and after 24 hours of exposure to a HCl vapour;

FIG. 12a is radar plot comparing physical properties of 3D objects printed with the different embodiments of the cellulose-based ink; and

FIG. 12b is a graph showing tensile strength and density of the different embodiments of the cellulose-based inks and other commodity plastics.

### DETAILED DESCRIPTION OF THE EMBODIMENTS

The disclosure is directed at a novel extrusion printable cellulose-based ink or nanocomposite and method of making same. In some embodiments, the disclosure is directed at an ink or nanocomposite that includes cellulose acetate (CA) and cellulose nanocrystals (CNC) that can be used for three-dimensional (3D) extrusion printing. Along with being used as a 3D-printable ink, the disclosure can also be used as a coating for different substrates including but not limited to metal substrates or paper substrates.

In some embodiments, the method of producing the ink or nanocomposite of the disclosure includes a tri-solvent wet blending method for dissolving CA powder. In other embodiments, the method of the disclosure includes a post-printing processing treatment of a 3D object printed with a cellulose-based ink of the disclosure to generate pores or voids within the 3D object. In some embodiments, the post-printing processing may be a porogen-based processing treatment.

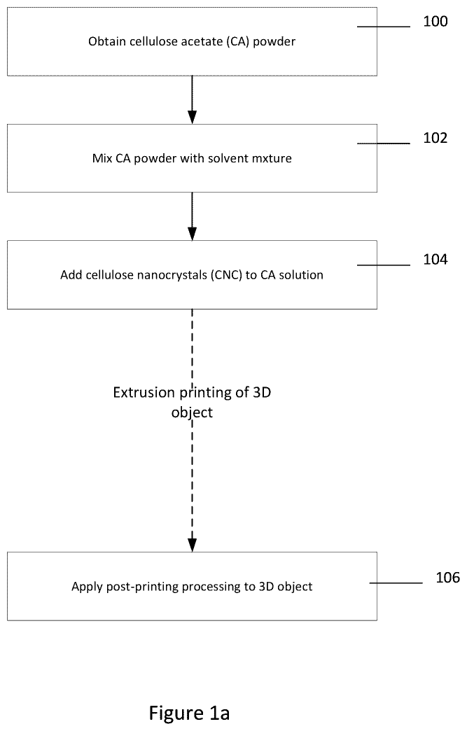

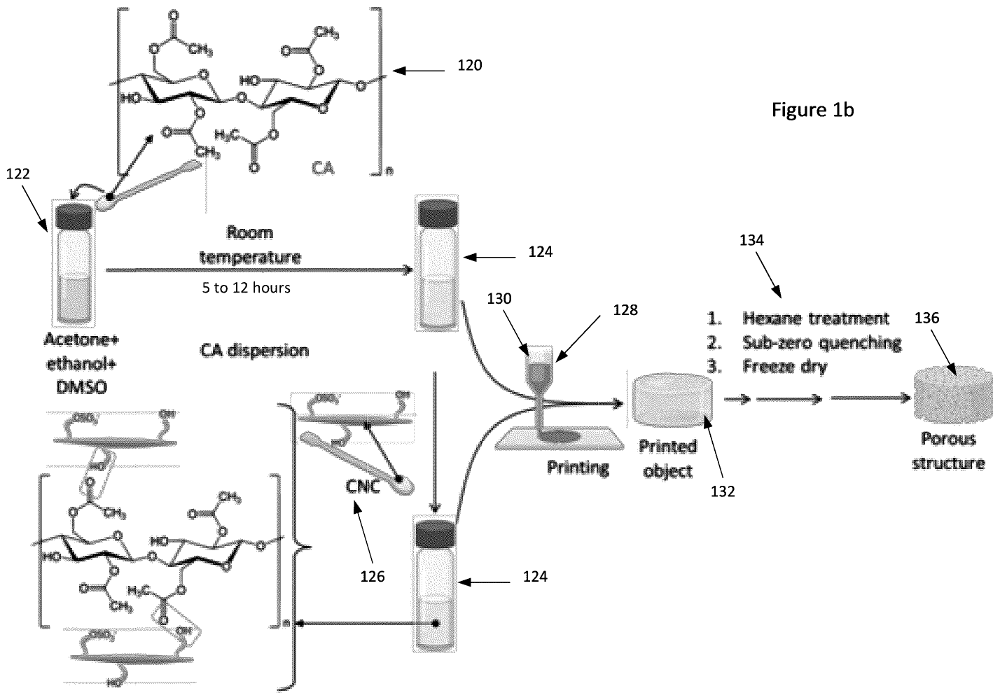

Turning to FIG. 1a, a flowchart showing a method of producing an extrusion printable cellulose-based ink or nanocomposite is shown.

Initially, a cellulose acetate (CA) powder is obtained (100). Characteristics of the CA powder may include, but are not limited to, high purity, low moisture content and/or fine particle size for uniform coating.

The CA powder is then mixed with a solvent mixture (102) to produce a CA solution. In some embodiments, the CA solution is produced by dissolving the CA powder in the solvent mixture. One specific example of a solvent mixture is a tri-solvent mixture including acetone, ethanol, and dimethyl sulfoxide (DMSO) in an approximate 5:5:2 volume ratio. In other embodiments, the solvent mixture may include other liquid components in the same or different volume ratio that is able to mix with or dissolve the CA powder. Different concentrations of CA are contemplated for the CA solution such as in the range of about 15 wt % to about 35 wt %. In some embodiments, the concentration of CA is in the range of about 22 wt % to about 28 wt %. In other embodiments, a prepared CA solution with predetermined characteristics or properties may be obtained such that (100) and (102) can be seen as being combined. These properties may include, but are not limited to, the CA at a specific concentration or a solvent mixture including at least one required or predetermined component.

The dissolution of the CA powder in the solvent mixture may be enhanced by agitation, shaking, stirring or heating such that the CA powder is completely dissolved within the solvent mixture.

Cellulose nanocrystals (CNC) are then added to the CA solution (104) including the CA powder and the solvent mixture to produce an embodiment of the ink of the disclosure. In some embodiments, instead of CNC, cellulose nanofibres, silica (fumed/colloidal), nanoclay or hydroxypropyl methlcellulose in broad cellulose fibres may be added to the CA solution. In some embodiments, derivatives of these materials may be added to the CA solution. The ink may then be used for the printing or fabrication of a 3D object or component via extrusion printing by a 3D-printer.

After the object has been printed using the CA-based ink, a post-printing processing technique or treatment is applied (106) to the resulting printed 3D object. The post-printing processing treatment may be a porogen-based treatment that applies or introduces pores or voids to the 3D object in order to reduce the weight of the final 3D object. The pores or voids may also decrease material consumption, enhance buoyancy, improve thermal and/or acoustic insulation, increase surface area for functionalization and/or enable tunable mechanical properties such as, but not limited to, flexibility or shock absorption.

In one specific embodiment of FIG. 1a, as schematically shown in FIG. 1b, a porous structure 136 was fabricated using a 25 wt % CA-based ink or nanocomposite. Initially, when preparing the 25 wt % CA-based ink, a CA powder 120 was obtained and then placed in or mixed with a solvent mixture 122 (such as the tri-solvent mixture discussed above) to produce the 25 wt % CA solution 124 and allowed to stand. In some embodiments, the CA solution can stand for about 5 hours to about 12 hours. In the current specific embodiment, the CA solution 124 stood for about 12 h. This resulted in a complete dissolution of the CA powder in the tri-solvent mixture and a bubble-free CA solution. CNCs 126 were then mixed into the CA solution 124 to produce a bubble-free CA-based ink or nanocomposite 128.

The CA-based ink 128 was then transferred into a cartridge 130, such as a 10 mL plastic syringe cartridge, which could then be inserted into a 3D printer. The 3D printer was then used to print or fabricate a printed 3D object 132. For this printing process, a single-use syringe with a 25-gauge tapered plastic nozzle was used in order to reduce or avoid fast heat dissipation that occurs when using a steel nozzle. Ink extrusion was enabled or facilitated using a pneumatic system (not shown). More specifically, for the printing of the 3D object 132 in this specific example, in order to maintain a steady ink flow, the feed rate was set to between about 12 to about 14 mm/s; the travel feed rate was about 22 mm/s and the extruding pneumatic pressure set to between about 6 psi to about 14 psi.

After the 3D object 132 was printed by the 3D printer via an extrusion printing process, the 3D object 132 underwent a post-printing processing treatment 134. More specifically, in one specific embodiment of a post-printing processing treatment, the 3D object 132 was cleaned off by rinsing the 3D object with n-hexane right after printing. It is understood that other methodologies for cleaning the 3D object are contemplated. The 3D object was then cryofreezed, such as by using liquid nitrogen. This may also be seen as sub-sero quenching. After undergoing cryofreezing, the 3D object was then freeze dried and then characterized, as required, resulting in the porous 3D object 136.

Experiments were performed on the ink and/or the resulting porous 3D object in order to verify the properties of the nanocomposite or ink of the disclosure. For extrusion based 3D printing inks, a desired property is that it is shear thinning as this enhances ink performance. As understood, viscosity and shear rate are inversely proportional.

In general, shear-thinning inks exhibit decreased viscosity under high shear rates during extrusion printing and then experience an increase in viscosity after solidification which leads to high-quality printed objects. Furthermore, in the field of 3D-printing, ink flow through fine deposition needles is improved due to shear-thinning.

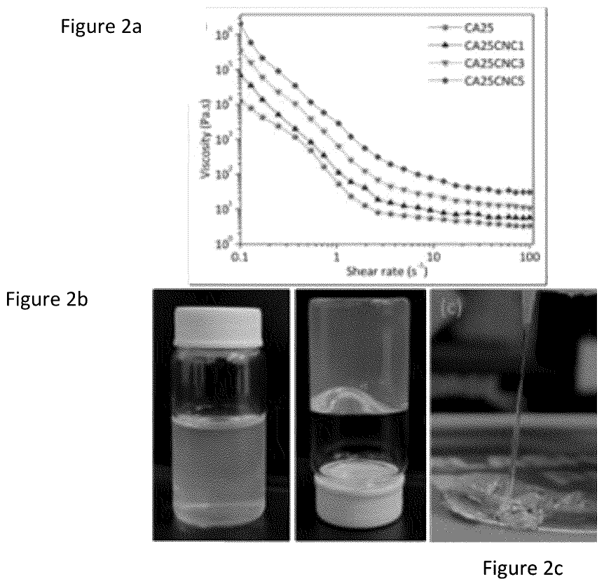

When the ink is subjected to shear forces between parallel plates, there is a relationship between viscosity and shear rate. This is shown in more detail in FIG. 2a which is a graph showing shear rate (X-axis) vs viscosity (Y-axis) for four (4) different embodiments of a 25 wt % CA-based ink with different levels of CNCs. CA25 represents a CA-based ink that does not include any CNC; CA25CNC1 represents a CA-based ink that includes 1 wt % CNC; CA25CNC3 represents a CA-based ink that includes includes 3 wt % CNC and CA25CNC5 represents a CA-based ink that includes includes 5 wt % CNC. The CNC wt % may be in relation to the total ink composition or relative to the CA content depending on the formulation methodology being used. As previously discussed, the wt % of CA in the cellulose-based ink can be modified and does not need to be only 25 wt %.

The shear thinning behaviour is characterised by a specific section of the curve where the viscosity shows a consistent and linear decline as the shear rate increases. This region is also known as the non-Newtonian region and can be precisely defined by the power law equation where the equation η=kγⁿ⁻¹ represents the relationship between viscosity (η), consistency index (k), and shear rate (γ). In other words, γ is the rate at which shear occurs and n represents the index of the power law where shear thinning fluids have a value of n<1, shear thickening fluids have a value of n>1 and Newtonian fluids have a value of n equal to 0.

For the inks that were being tested, the consistency of the CA25 ink is shown before (left) and after (right) vial inversion in FIG. 2b. FIG. 2c is a photograph showing the ink consistency when the CA25 ink was extruded out from a tapered nozzle of the 3D printer.

Considerations were also made to address the Barus effect, which is observed in extrusion-based 3D printing processes when the ink (which may also be seen as an extrudate filament material) is pressurized and extruded through the 3D printer nozzle. Upon exiting the nozzle, the ink undergoes rapid solidification due to a temperature gradient which can lead to challenges such as, but not limited to, dimensional inaccuracies, surface imperfections, internal stresses and/or speed limitations in the printing process. By selecting specific components for the solvent mixture (and resulting CA solution) and subjecting the printed 3D object to the post-printing processing treatment, the Barus effect can be reduced or mitigated. Table 1 shows the testing results of different solvent or solvent-polymer mixtures for the CA solution.

TABLE 1
Optimization of ink printability in
different solvent-polymer systems

| | | Solution behaviour & |
|---|---|---|
| Solvent | Solubility | extrudability |
| Water | Insoluble | Insoluble mass |
| Water with surfactant | Insoluble | Insoluble mass |
| (Tween 80) | | |
| IPA | Insoluble | Insoluble mass |
| Ethanol | Insoluble | Insoluble mass |
| DCM | Insoluble | Insoluble mass |
| Ethyl acetate | Partially | Segregated mass |
| | soluble | |
| Acetone | Soluble | Paste extruded rapidly, |
| | | but tip blockage occurred |
| | | due to drying of |
| | | the paste over time |
| Acetone/water (1:1 ratio) | Insoluble | Segregated mass |
| Acetone/ethanol (1:1 ratio) | Insoluble | Gummy mass |
| Acetone/isopropyl alcohol | Insoluble | Gummy mass |
| (1:1 ratio) | | |
| Acetone/propylene glycol | Soluble | Paste but hindered |
| (4:1 ratio) | | extrusion |
| Acetone/isopropyl alcohol | Soluble | Paste but no continuous |
| (3:2 ratio) | | extrusion |
| Acetone/ethanol/DMSO | Soluble | Good uniformity and |
| (5:5:2 ratio) | | continuously extrudable |
| | | paste |

While one specific embodiment of the disclosure includes a solvent mixture of Acetone/ethanol/DMSO in a (5:5:2 ratio), other solvent mixtures such as ethyl acetate, methyl ethyl ketone (MEK), dimethyl carbonate (DMC) or acetone-ethanol mixtures are also contemplated.

For the specific embodiment described above with respect to FIG. 1b, the CA exhibited a strong affinity for the acetone/ethanol/DMSO solvent mixture which was characterized by the low surface tension. The strong attraction for the polymer, or CA, led to significant swelling, which stands in contrast to the cohesive force. This could be explained in terms of the draining and non-draining phenomenon of CA-solvent interactions. Solvent molecules in a “draining solvent” system exhibit a tendency to undergo separation from the polymer (CA) molecules. Other elements or factors may further contribute to this phenomenon, including variations in temperature, pressure and low polymer-solvent interactions. Consequently, solvent evaporation or migration away from the polymer matrix may occur, or the amount of solvent surrounding the polymer molecules may decrease when in the mixture. On the other hand, for a “non-draining solvent” system, the solvent molecules stay connected to the polymer molecules.

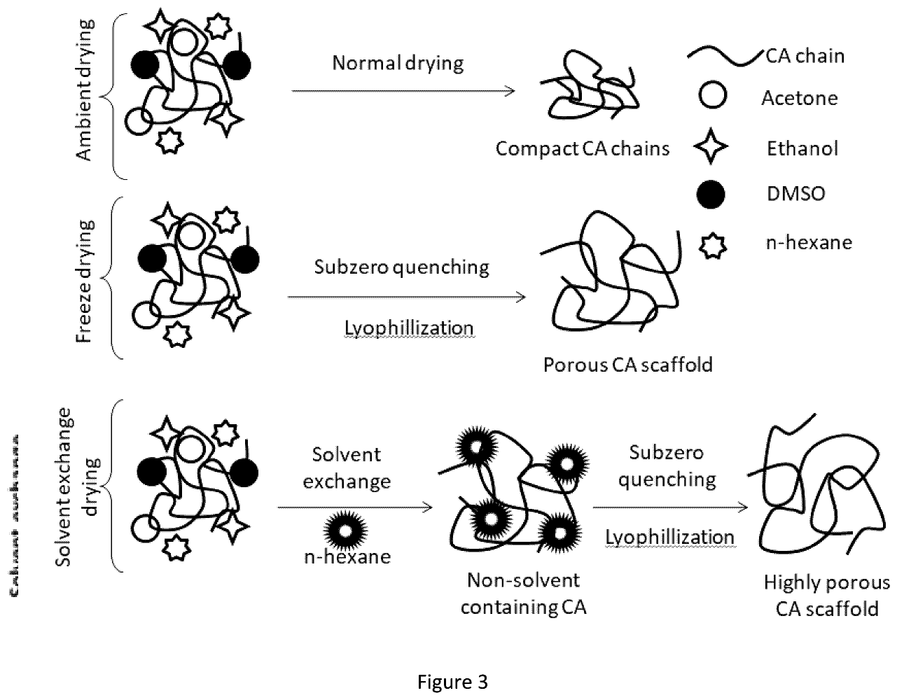

Stable interactions, such as hydrogen bonding or dipole-dipole interactions, may arise when the solvent mixture has a high affinity for the polymer, or CA. Within these systems, the solvent mixture exhibits a reduced propensity for evaporation or migration from the polymer molecules or matrix, thereby ensuring the preservation of a stable environment for the polymer molecules. In one specific embodiment of the disclosure, the tri-solvent mixture acts as a “non-draining” solvent system which interacts with the macrochains of the CA. During the post-printing processing treatment, when n-hexane was used as a rinsing agent, the “non-draining” tri-solvent mixture was replaced by the lighter draining solvent (n-hexane). When exposed to ambient drying, the CA machochains coalesce to form a compact assembly whereas for non-solvent based post-printing processing, the macrochains are not close enough to coalesce together. This results in a lighter and less dense network of CA chains as schematically shown in FIG. 3. Theoretically, as the solvent mixture in the pores (introduced by a porogen post-printing processing treatment) evaporates at a faster pace, the acting force to shrink increases. If the draining solvent, n-hexane, has a low surface tension, the impact will be diminished or reduced. The reduced evaporation time leads to the formation of numerous small-sized pores, effectively inhibiting or reducing the movement of solutes.

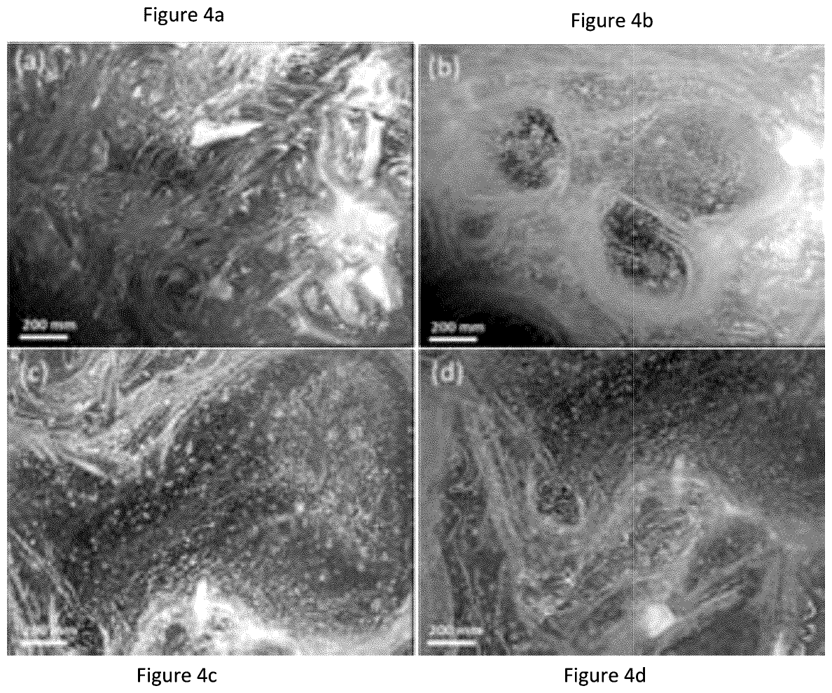

Turning to FIGS. 4a to 4d, scanning electron microscope (SEM) or optical microscope images of the surface textures and internal morphology of four embodiments of the CA25 inks are provided. FIG. 4a shows the surface textures of a 3D object printed using a neat CA25 ink (without CNC), FIG. 4b shows the surface textures of a 3D object printed using a CA25CNC1 ink, FIG. 4c shows the surface textures of a 3D object printed using a CA25CNC3 ink and FIG. 4d shows the surface textures of a 3D object printed using a CA25CNC5 ink.

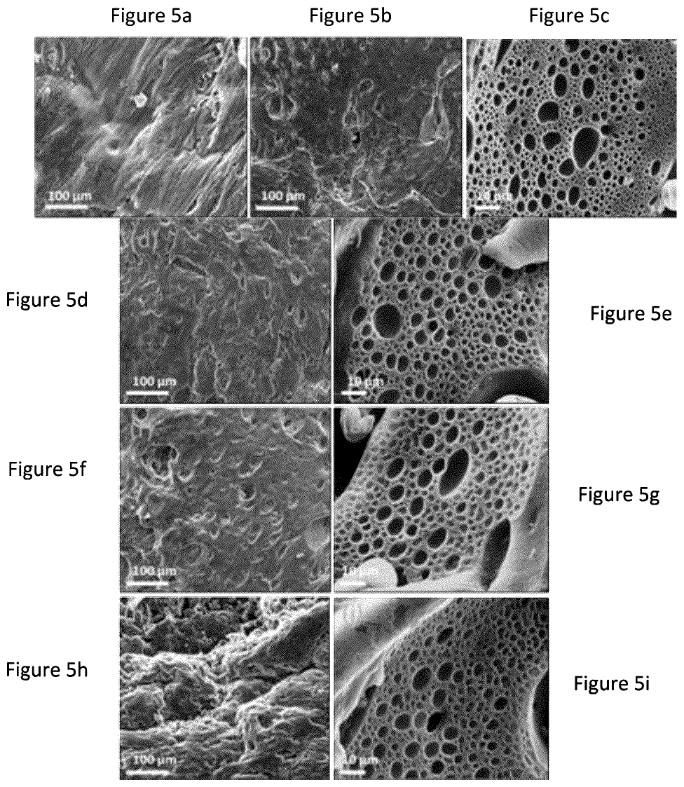

For some image captures, the post-printing processed and casted samples for the 3D object were cryofractured before being viewed under the scanning electron microscope. This is shown in more detail in the images of FIGS. 5a to 5i.

FIG. 5a is a SEM image of a 3D object that was printed using the neat CA ink (CA25 ink) that was then casted and dried under ambient conditions. As can be seen in FIG. 5a, the surface includes parallel veins at the cryofractured surface. For the solvent treated samples, the morphology was rougher and creases were present throughout the cryofractured surfaces.

For 3D objects that were printed with the CA25 or the other embodiments of the CA25CNC? inks, the porosity was not significantly affected as shown in the photographs of FIGS. 5b to 5i. FIG. 5b is a SEM image of a post-printing processed 3D object or scaffold printed with the CA25 ink while FIG. 5c is a magnified image of the porous surface of FIG. 5b. FIG. 5d is a SEM image of a post-printing processed 3D object or scaffold printed with the 1 wt % CNC loaded CA-based ink (CA25CNC1) while FIG. 5e is a magnified image of the porous surface of FIG. 5d. FIG. 5f is a SEM image of a post-printing processed 3D object or scaffold printed with the 3 wt % CNC loaded CA-based ink (CA25CNC3) while FIG. 5g is a magnified image of the porous surface of FIG. 5f. FIG. 5h is a SEM image of a post-printing processed 3D object or scaffold printed with the 5 wt % CNC loaded CA-based ink (CA25CNC5) while FIG. 5i is a magnified image of the porous surface of FIG. 5h.

In many current polymer composites that are used for 3D printing, fillers are included in relatively small quantities relative to the polymer matrix. Generally, these fillers include nanoparticles or microparticles, which possess dimensions significantly smaller than the gaps or pores present within the polymer matrix. Consequently, the composite material's total porosity is largely unaffected by their presence. Effective surface treatment, functionalization, or compatibility of fillers can enhance the interfacial adhesion between the filler particles and the polymer matrix, hence preventing or reducing any disruption to the polymer network's continuity or the formation of extra voids. With respect to the images in FIG. 5 of the surfaces of 3D objects printed using the embodiments of the cellulose-based ink that included CNC, there was no agglomeration or non-uniformity noticed which indicates a strong compatibility of CNCs with the CA matrix.

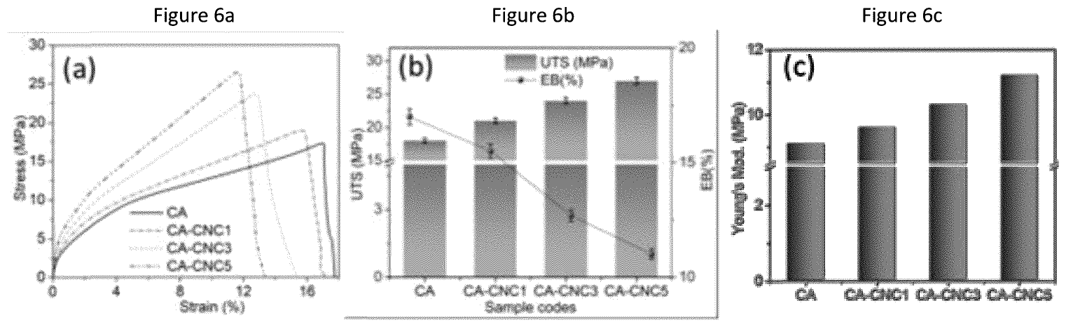

In order to better understand the mechanical properties of 3D objects that were printed using the different embodiments of the CA25-based inks (either neat or with CNC), different tests and experiments were performed. With respect to the stress and strain parameters, FIG. 6a is a graph showing the stress-strain plot of the CA25 ink and the other CA25CNC? nanocomposites or inks. For the CA25 ink, the highest tensile strength that was measured was approximately 16 MPa. As can be seen in FIG. 6a, the tensile strength increased as more CNC was added to the final ink product. For the CA25CNC1 (1 wt % CNC) ink, the increase in tensile strength was negligible but for the CA25CNC3 (3 wt % CNC) ink and the CA25CNC5 (5 wt % of CNC) ink, the tensile strengths were approximately 22 MPa and approximately 26 MPa, respectively.

As CA is a plastic, the elongation at break was very low (approximately 18%) which was minimized or reduced with the increase of the level, amount or weight of CNCs in the CA-based inks. It is expected that the improvement of tensile behaviour or strength is related to the reinforcing nature of CNCs. A histogram plot (as schematically shown in FIG. 6b) shows ultimate tensile strength (UTS) and elongation at break for the different embodiments of the CA25-based inks. By incorporating CNCs into the CA matrix, the CNCs serve as reinforcements, efficiently bearing weight and equally dispersing stress over the finished printed 3D object or product. This may also be referred to as load transfer.

Load transfer generally occurs from a less elastic phase (such as when printing using the neat CA-based ink) to a more elastic phase (such as when printing or using the embodiments of the CA-based inks with different concentrations of CNCs). The transfer of load from the CA matrix to the CNCs (in the CACNC based inks) occurs when an external force is exerted on the printed 3D object. The CACNC based inks are capable of withstanding higher forces without fracturing due to the higher tensile strengths as discussed above. This results in a reduction or mitigation of substantial deformation or failure of the printed 3D object or the polymer ink/composite material that is used to print the product when subjected to tension. Moreover, the CNCs reduce the likelihood of crack propagation inside the composite material or ink or printed 3D object. When fractures promote to propagate within the printed 3D object, the fractures come into contact with the CNCs, which serve as obstacles, hindering their progression which leads to a printed 3D object that is more resistant to fracture. The elastic moduli of the neat CA-based ink and the CA25CNC? based inks were also evaluated and results shown schematically in FIG. 6c.

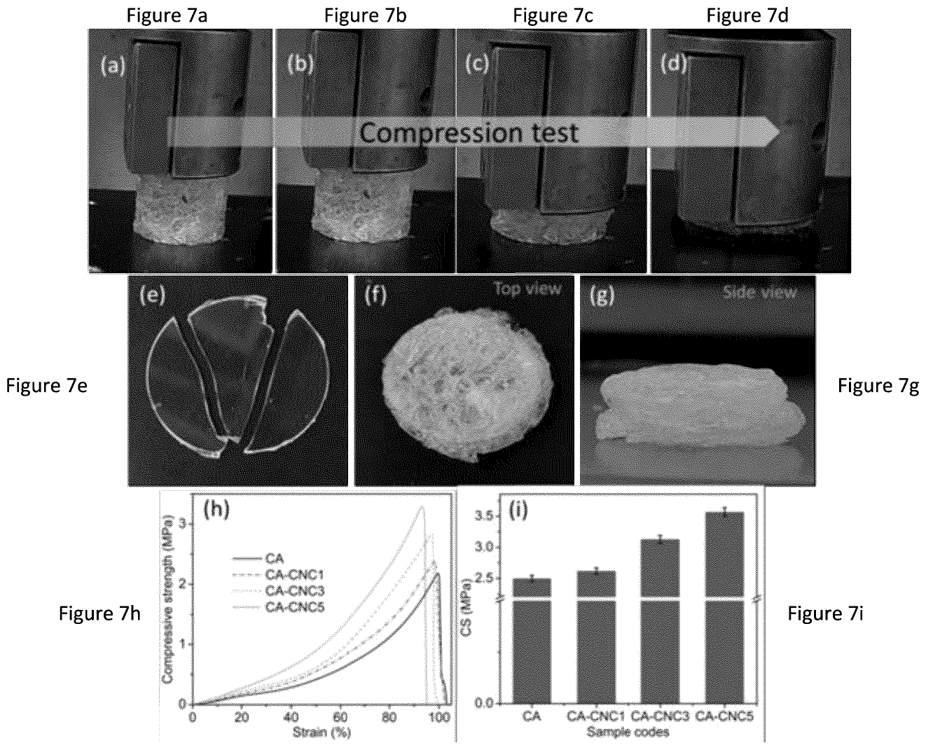

The printed 3D objects or products were also placed under compression tests as schematically shown in the photographs of FIG. 7a to FIG. 7d which are directed at the compression test of the 3D object (which in this example can be seen as a cylindrical scaffold). In order to further test the resulting printed 3D objects in comparison with commercially available products, a product fabricated or printed using polystyrene was placed under the same compression conditions with the resulting broken polystyrene specimen shown in the photograph of FIG. 7e. It can be seen in FIG. 7e that the product or 3D object printed from commercially available polystyrene experienced a brittle fracture in comparison with the 3D objects fabricated from the CACNC-based inks of the disclosure where there was no brittle fracture even after subjected to a completely compressed state. The images of FIGS. 7f and 7g, which are top and side views of the cylindrical scaffold after undergoing a compression test. As can be seen in FIGS. 7f and 7g, there are no fracture marks in the scaffold after the compression test. It is expected that in contrast to brittle materials, ductile materials such as CA retain the ability to experience substantial deformation prior to experiencing fracture. The malleability of the CA-based or CA-CNC based inks (or hardened ink after printing) enables it to effectively absorb energy via plastic deformation mechanisms thereby mitigating or reducing the risk of abrupt and severe failure commonly associated with brittle fracture. The inclusion of CNCs within the CA-based ink additionally enhances the material's durability. It is expected that the CNCs function as impediments to the propagation of fractures, impeding or reducing the progression of cracks and augmenting the energy necessary for fracture. Therefore, the 3D object printed with the CACNC-based inks exhibit a reduced susceptibility to brittle failure as reflected in the compressive stress-strain plot of FIG. 7h. Similar with respect to tensile behaviour or tensile strength, the CNC reinforced composites (CACNC-based inks) also show a gradual increment of or increase in compressive strength as shown in the graph of FIG. 7i.

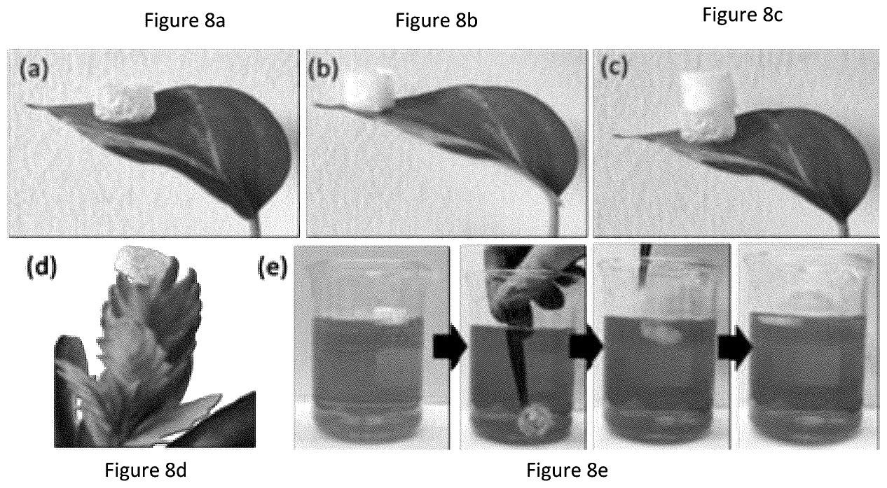

A weight of the 3D objects that were printed using the inks of the disclosure was also tested. In testing, it was determined that the weight of the printed 3D objects was relatively lightweight which can be attributed to the low density of the ink used to print the 3D objects and/or the post-printing processing of the 3D object(s). The molecular matrix of the 3D objects printed with the CA-based ink encapsulates a substantial quantity of air. Due to the significantly lower density of air compared to water, the 3D objects printed with the CA-based or CA-CNC based inks have a lower overall density, enabling it to float. The CA-based printed inks exhibit a closed-cell configuration where the constituent cells or bubbles within the printed ink are well isolated from one another. The closed-cell structure of the printed inks limits water infiltration and density increase, hence maintaining its buoyancy. FIGS. 8a to 8c are photographs showing the lightweight behaviour of a 3D object printed using different embodiments of the ink of the disclosure on top of a leaf. As can be seen, the 3D printed object does not cause the leaf to droop and does not fall off due to its weight. Furthermore, as shown in FIG. 8d, the printed 3D object can be supported by the petals of a flower. As understood, these 3D objects may or may not undergo a post-printing processing treatment.

The printed 3D objects were also subjected to a water dipping test whereby the 3D object was pressed into water. Food dye was added to the water to improve visualization. As can be seen in the progression of images in FIG. 8e, the 3D object was pushed to the bottom of the container but once the pressure was released, it floated immediately to the top of the container.

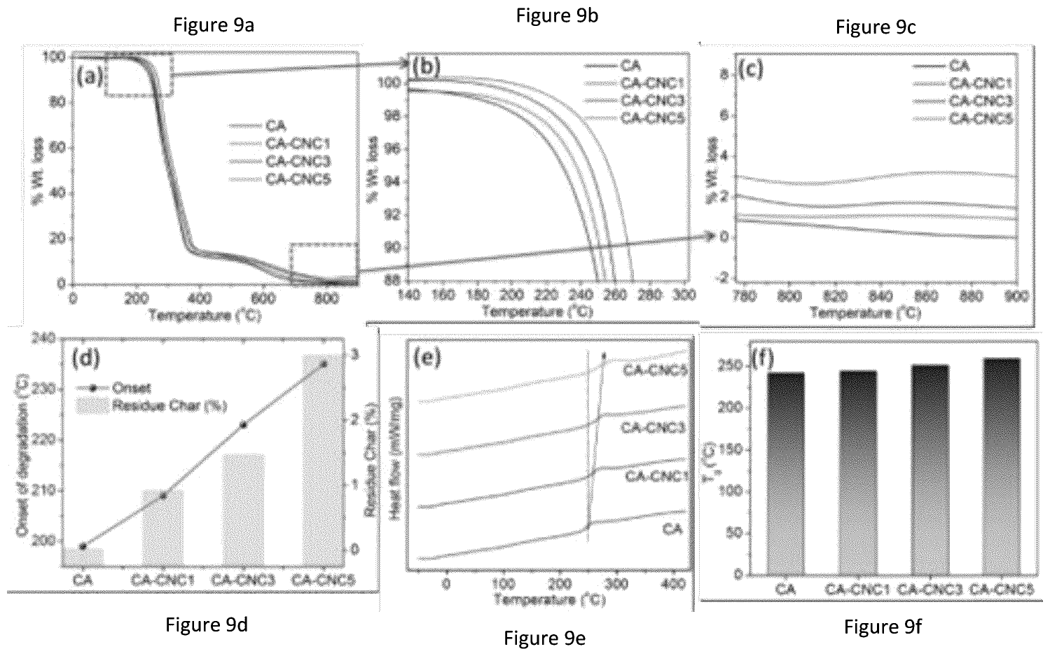

The CA25 and CA25CNC? inks were also tested for their thermal stability by placing the 3D objects fabricated with these inks under a Thermogravimetric analysis (TGA). Results of the TGA for the CA25 and the CA25CNC? inks are shown in FIG. 9a. In reviewing the TGA analysis, three primary thermal events were revealed or noted.

The first thermal event was the release of water that was adsorbed in the CA structure and the evaporation of volatile compounds (occurring between about 30 to about 200 degrees Celsius). The second thermal event was the pyrolytic decomposition of the CA polymer chain skeleton accompanied by deacetylation, as well as the decomposition of hemicellulose and lignin chains (occurring between about 200 to about 380 degrees Celsius). The third thermal event was the carbonisation of degradation products (occurring between about 380 to about 600 degrees Celsius).

The water desorption accounted for approximately 6% of the total mass loss during the TGA while approximately 68% of the mass loss was attributed to the decomposition and deacetylation of the polymeric chain and approximately 8% of the mass loss resulted from the carbonisation of degradation products.

In the CA-CNC based inks, the CNCs enhanced the thermal stability of the polymer or CA nanocomposites due to their elongated shape, robust intermolecular hydrogen bonding and/or efficient distribution within the polymer matrix. The CNCs impede or reduce the movement of polymer chains and serve as physical obstacles to the transfer of heat which decreases the speed at which polymers break down at high or higher temperatures. Furthermore, as CNCs possess a high thermal stability, the CNCs contribute to the thermal performance of the ink that results from the CACNC-based ink being used to print the 3D object or product. As can be seen in FIG. 9b, the onset of degradation has a right shift towards higher temperatures (approximately 22° C. for the 5 wt % CACNC-based ink printed product) with increasing CNC content. The residue/char fraction for the 3D object printed with the neat CA-based ink (in the absence of CNCs) was below 1% whereas for the CACNC-based inks or nanocomposites, the residual amount was calculated to be approximately 3.2% for the 5 wt % CNC (CA25CNC5) filled sample or printed 3D object implying the presence of CNC in the CA nanocomposite (schematically shown in FIG. 9c). The onset degradation temperatures and residue content for all the CACNC-based inks or nanocomposites and the CA25 ink are shown in FIG. 9d.

A thermal analysis of the CA25 and the CA25CNC-loaded or -based inks is shown in FIG. 9e. The neat CA ink exhibited a significantly elevated glass transition temperature in close proximity to its melting temperature. CA undergoes acetylation, which introduces acetyl groups that disrupt the intermolecular hydrogen bonding network found in natural cellulose. As a result, the crystallinity of cellulose is reduced and its amorphous regions are increased. The observed glass transition occurs when the amorphous regions acquire enough thermal energy due to an increase in temperature, allowing them to surpass the intermolecular forces that keep them fixed in position. The glass transition temperature (T_{g}) of the neat CA-based ink was about 240° C. but after the addition of CNCs, the T_{g} was increased gradually as shown in the chart of FIG. 9f. It is expected that the presence of CNCs hinders the movement of polymer chains, thereby raising the energy needed for the polymer to shift from a glassy to a rubbery state. The restriction of CA chains can result in an elevated T_{g}. In addition, CNCs can engage in interacting with polymer chains, thereby strengthening the interface between the CA and CNCs and improving the T_{g} of the composite material or the printed ink. Furthermore, CNCs have the ability to decrease the available space within the CA structure, leading to a higher density of polymer chains and an elevated T_{g}.

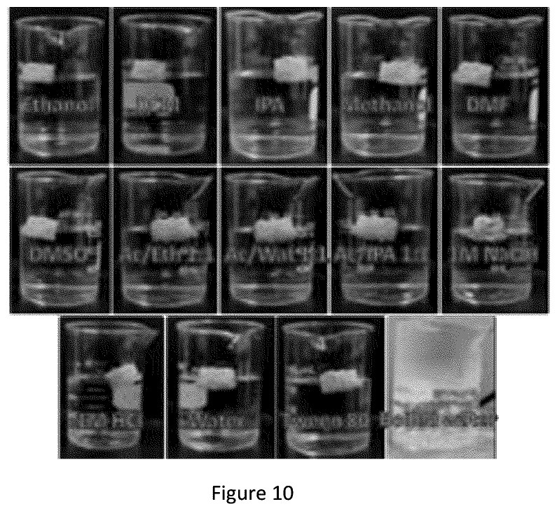

The solvent resistance of the inks of the disclosure was also tested. Solvent resistance tests were performed in different polar and non-polar solvents as schematically shown in the set of photographs of FIG. 10. Due to its distinctive chemical structure and characteristics, CA demonstrates resistance to both polar and non-polar solvents or solvent mixtures. As CA is generated from cellulose and goes through a process in which hydroxyl groups are substituted with acetate groups, this results in a decrease in its overall polarity. The reduced polarity, along with its heightened hydrophobicity, provides protection from interactions with polar solvents such as, but not limited to, water. In addition, the presence of large acetate groups results in steric hindrance, which hinders the ability of solvents to penetrate the polymer, hence delaying its dissolution or breakdown. The CA maintains a certain degree of polarity as a result of the presence of ester groups, which enables it to engage in weak interactions with polar solvents. Furthermore, the presence of van der Waals forces has a significant role in its ability to resist non-polar solvents. The combination of these properties contributes to the resistance of CA to a diverse array of solvents or solvent mixtures.

The inks of the disclosure were also applied as an anti-corrosion coating. The anti-corrosion test was performed in the presence of a HCl vapour. The mass loss was also monitored for both an uncoated (bare) Aluminum (Al) strip and an Al strip coated with an CACNC-based ink of the disclosure where the uncoated Al strip experienced a significant weight loss.

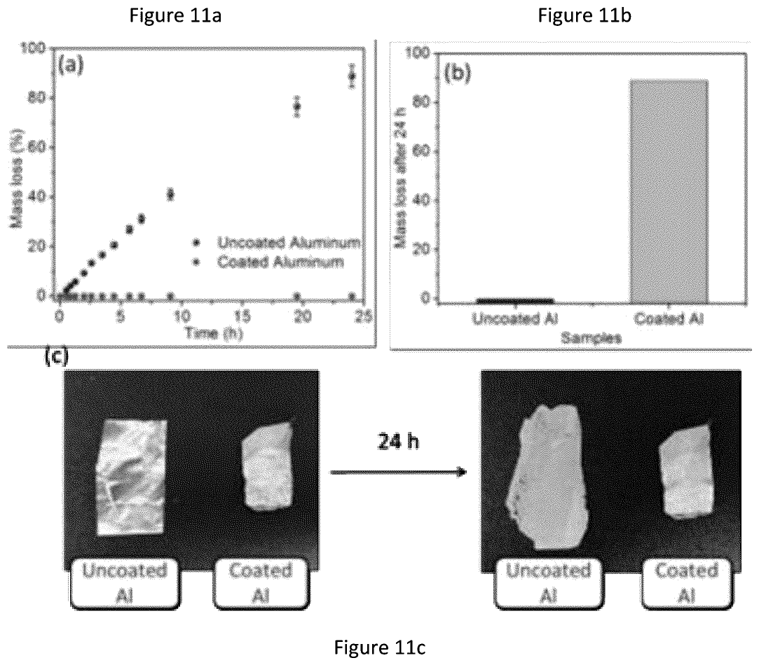

Within the first 2 hours, the weight loss was around 4.5% due to the formation of salt over the surface of the base of the uncoated Al strip. The corrosion of aluminium occurs when exposed to hydrochloric acid vapor resulting from a chemical interaction between the surface of the aluminium and the acidic vapor. For the coated Al strip, there was no weight loss noticed during the experiment. It is expected that the acid vapors could not penetrate the coating layer of the ink of the disclosure due to the inertness of the CA-based coating formulation with acid. The time dependent mass loss was monitored and plotted in FIG. 11a. Moreover, for a 24 hour time slot, the mass loss for the uncoated and coated Al strips was also tested where there was a 90% change in mass for the uncoated Al strip and where there was no change in mass for the coated Al strip. This is shown in more detail in the graph of FIG. 11b. The digital images of FIG. 11c show the coated and uncoated Al strips before and after 24 hours of acid vapor exposure.

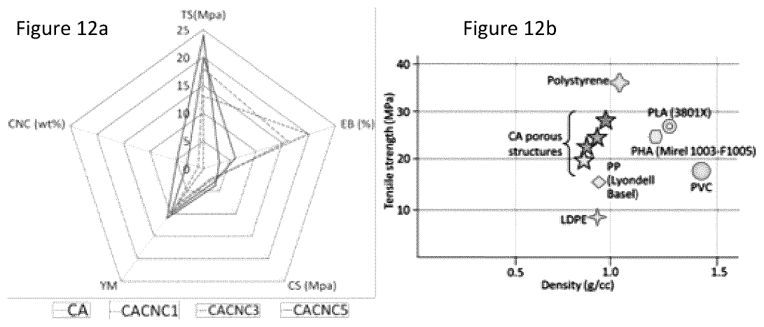

The inks of the disclosure were also compared with each other with the results schematically shown in FIG. 12a. FIG. 12a is a radar plot showing how mechanical properties are changed with different CNC concentrations. The radar plot also depicts the physical features of the different printed objects against different variables.

For the 3D object printed using the neat CA ink, the ductility was at its highest value or level but the ductility decreased significantly as the CNC was added to the CA-based inks and the CNC level increasing. A comparison of the characteristics of the printing ink with other commercially available materials (especially plastics) is provided in FIG. 12b. FIG. 12b focuses on the lightweight property of the CA-based printed ink or nanocomposites. The density-to-strength ratio evaluates the strength of a substance in relation to its density which provides information about its performance in relation to its mass. In general, a high density-to-strength ratio is normally required for high strength applications. As shown in the plot of FIG. 12b, the ultimate tensile strength of the different CA-based inks of the disclosure have a gravity of below 1 which is lighter than water and am improvement relative to other currently available plastics.

In other embodiments, the CA-CNC based inks of the disclosure can be used as a coating for paper substrates. In experiments, it was determined that using the CA-CNC based inks as a coating resulted in more than an hour of stability in a steam/boiling water environment with little to zero deformation/textural changes to the paper substrate. This was validated using immersion tests. The coated paper substrate also demonstrated solvent resistance against different solvents, such as ethanol, dichloromethane (DCM), isopropyl alcohol (IPA), methanol, N,N-Dimethylformamide (DMF), dimethyl sulfoxide (DMSO), 1M HCl/NaOH or Tween. Furthermore since the ink of the disclosure includes 100% cellulose derivatives+nanofillers, it is a plastic-free composition. When used as a coating for the paper substrate, the coating also provided a hydrophobic barrier for the paper substrate with a water contact angle greater than 90 degrees and exhibited no leakage during week-long liquid holding tests. The combination of the coating and paper substrate may find application in hot/cold beverage cartons to replace PE/PLA liners; take-out containers; eco-pouches and/or frozen food packaging.

In some embodiments, with respect to material properties, the inks of the disclosure had a tensile strength that can be tuned between 16 MPa and 26 MPa. In other embodiments, the disclosure retained the ability to experience substantial deformation whereby no brittle fracture was observed even after complete compressed state. In other embodiments, the disclosure is lightweight and has a low density. In other embodiments, the disclosure had a thermal stability at temperatures greater than about 250° C. In yet other embodiments, the disclosure showed resistance to both polar and non-polar solvents.

Advantages of the disclosure include, but are not limited to, the ink of the disclosure can elastically deform and avoid fractures observed in 3D objects printed with commercially available plastics. Another advantage is that the ink of the disclosure has higher a thermal stability than cellulose acetate alone due to the addition of the CNCs. Another advantage of the ink of the disclosure is that it is resistant to water and HCl vapor as well as common liquid solvents such as, but not limited to, isopropyl alcohol, hydrochloric acid, sodium hydroxide, and dimethyl sulfoxide. Another advantage of the disclosure is that when the ink is used as a coating on aluminum, there is a noticeable resistance to corrosion by water and HCl vapor.

Other advantages of the disclosure include environmental sustainability since the use of CA is obtained from renewable cellulose. The disclosure is also biodegradable since the nanocomposites based on CA possess inherent biodegradability allowing them to decompose over time without leaving detrimental residues. The disclosure also provides customization and/or design flexibility enabling the extrusion printing of complex shapes and customized components, parts or articles. The disclosure also demonstrated enhanced strength, durability, and heat resistance, in comparison to conventional plastics. The disclosure also provides safety and biocompatibility since the ink or nanocomposites of the disclosure are non-toxic and biocompatible.

The ink of the disclosure may be used to extrusion print components or parts in different technology fields including medical devices, medical implants, drug delivery systems, food packaging, automotive, aerospace and/or electronics casings.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

What is claimed is:

1. A method of producing an ink for extrusion printing by a three-dimensional printing comprising:
dissolving cellulose acetate (CA) powder in a solvent mixture to produce a CA solution; and
adding cellulose nanocrystals (CNC) to the CA solution to produce the ink.

2. The method of claim 1 wherein the solvent mixture comprises at least two different liquid components.

3. The method of claim 2 wherein the solvent mixture is a tri-solvent mixture.

4. The method of claim 3 wherein the tri-solvent mixture comprises acetone, ethanol, and dimethyl sulfoxide (DMSO).

5. The method of claim 1 wherein dissolving CA powder in a solvent mixture comprises:
adding CA powder to the solvent mixture in a container; and
agitating, shaking, stirring or heating the container.

6. The method of claim 1 wherein the CA solution is between about 15 wt % to about 38 wt % CA.

7. The method of claim 6 wherein the ink is between about 1 wt % CNC to about 5 wt % CNC.

8. An ink for extrusion printing using a three-dimensional printer comprising:
a cellulose acetate (CA) powder;
a solvent mixture; and
cellulose nanocrystals (CNCs).

9. The ink of claim 8 wherein the CA powder is dissolved in the solvent mixture to produce a CA solution.

10. The ink of claim 9 comprising about 15 wt % to about 25 wt % CA.

11. The ink of claim 9 comprising about 1 wt % to about 5 wt % CNC.

12. The ink of claim 9 wherein the solvent mixture comprises acetone, ethanol, and dimethyl sulfoxide (DMSO).

13. A method of fabricating a three-dimensional (3D) object comprising:
producing a cellulse-based ink;
printing, via extrusion, the 3D object using a 3D printer; and
performing a post-printing treatment to the 3D object.

14. The method of claim 13 wherein producing a cellulose-based ink comprises:
dissolving cellulose acetate (CA) powder in a solvent mixture to produce a CA solution; and
adding cellulose nanocrystals (CNC) to the CA solution to produce the cellulose-based ink.

15. The method of claim 13 wherein performing a post-printing treatment to the 3D object comprises:
applying a porogen-based treatment to the 3D object.

16. The method of claim 15 wherein applying the porogen-based treatment to the 3D object comprises:
rinsing the 3D object with n-hexane;
cryofreezing the 3D object; and
freeze drying the 3D object.
